(19) United States
(12) Patent Application Publication
(10) Pub. No.: US 2003/0201648 A1
(43) Pub. Date: Oct. 30, 2003

(54) Latch door

(76) Inventors: Stefan Pagowski, Glen Ellyn, IL (US); Apolinarion Balot, Plaines, IL (US)

Correspondence Address: JAMES RAY & ASSOCIATES, 2640 Pitcairn Road, Monroeville, PA, 15146, US

(21) Appl. No.: 10/134,869

(22) Filed: Apr. 29, 2002

(51) Int. Cl. E05B 3/00

(52) U.S. Cl. 292/336.3

(57) ABSTRACT

A latch door operator if provided for use with an electrical door operator for improving the sealing capabilities of a plug door commonly used in multi-passenger mass transit vehicles. The essential components of the latch door operator comprise a striker member suspended within the door frame which cooperates with a catcher member which is pivotally mounted to the door. The striker member is capable of moving in one of a first and second direction upon the application of a force thereto. An actuating device is provided for applying one of an actuating and retracting force to the striker member. The striker member also includes a nose portion located at a first end thereof. The catcher member, which is mounted to the door, has a first end portion which is capable of cooperating with the nose portion of the striker member upon the application of an actuating force to the striker member. This actuating force causes the striker member to move in a first direction to compress the sealing member associated with the door to one of a wall portion or door frame of the transport vehicle and to latch the door in a closed position.

### FIELD OF THE INVENTION

This invention relates generally to a latch door operator for use with electrically driven rotary door operators for multi-passenger mass transit vehicles, more particularly to a latch door operator for improving the sealing capability of a swingably mounted door such as used in multiple passenger vehicles including airport utility transports, school buses, and small transit buses.

### BACKGROUND OF THE INVENTION

Various types of single bus type door closing systems are known. Examples of these known systems are described in U.S. Pat. Nos. 4,282,686; 4,924,625; 4,932,715; 5,263,280 and 5,421,395, the specifications of which are hereby incorporated by reference. Door panels of mass transit vehicles are often subjected to significant forces caused by side air flow. Such forces can result in undesirable wear on the seals of the door, leakage of air through the door and/or undesirable opening of the door during movement of the vehicle. There is a need in the art for a latching device capable of overcoming these inherent deficiencies of the prior art.

### SUMMARY OF THE INVENTION

The present invention relates to a latch door operator for use with an electrical door operator for improving the sealing capabilities of a plug door commonly used in multi-passenger mass transit vehicles. A sealing means is provided on one of or both of the edge of the door and/or on or within the door frame/wall portion of the vehicle. The essential components of the latch door operator comprise a striker member suspended within the door frame which cooperates with a catcher member which is pivotally mounted to the door. The striker member is capable of moving in one of a first and second direction upon the application of a force thereto. An actuating means is provided for applying one of an actuating and retracting force to the striker member. The striker member also includes a nose portion located at a first end thereof. The catcher member, which is mounted to the door, has a first end portion which is capable of cooperating with the nose portion of the striker member upon the application of an actuating force to the striker member. This actuating force causes the striker member to move in a first direction to compress sealing means associated with the door to one of a wall portion or door frame of the transport vehicle and to latch the door in a closed position.

### OBJECTS OF THE INVENTION

It is therefore an object of the invention to improve the sealing capability of a swingably mounted door such as used in multiple passenger vehicles.

It is a further object of the invention to minimize the frictional drag of the striker member during movement thereof and to form the cooperating ends of the striker member and the catcher member from friction reducing materials.

It is another object to design the latch operator such that during actuation of the striker member, interruption of the seals is prevented.

It is still another object to design the latch operator such that a portion of the striker member fits within the vehicle wall.

It is yet another object to design the latch operator such that the catcher maintains pressure on the door and compensates for wear of the seals and operational tolerances.

In addition to the objects and advantages listed above, various other objects and advantages of the latch door operator disclosed herein will become more readily apparent to persons skilled in the relevant art from a reading of the detailed description section of this document.

### BRIEF DESCRIPTION OF THE DRAWINGS

FIG. 1 shows a top view of the latch door operator of the invention.

FIG. 2 shows an alternative view of the latch door operator of FIG. 1 from the perspective taken along line I-I.

### DETAILED DESCRIPTION OF THE INVENTION

The following background information is provided to assist the reader to understand the environment in which the invention will typically be used. The terms used herein are not intended to be limited to any particular narrow interpretation unless specifically stated otherwise in this document.

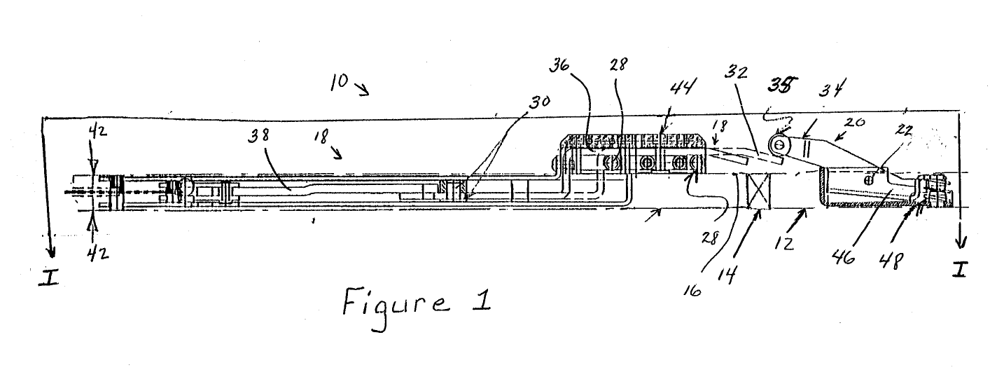

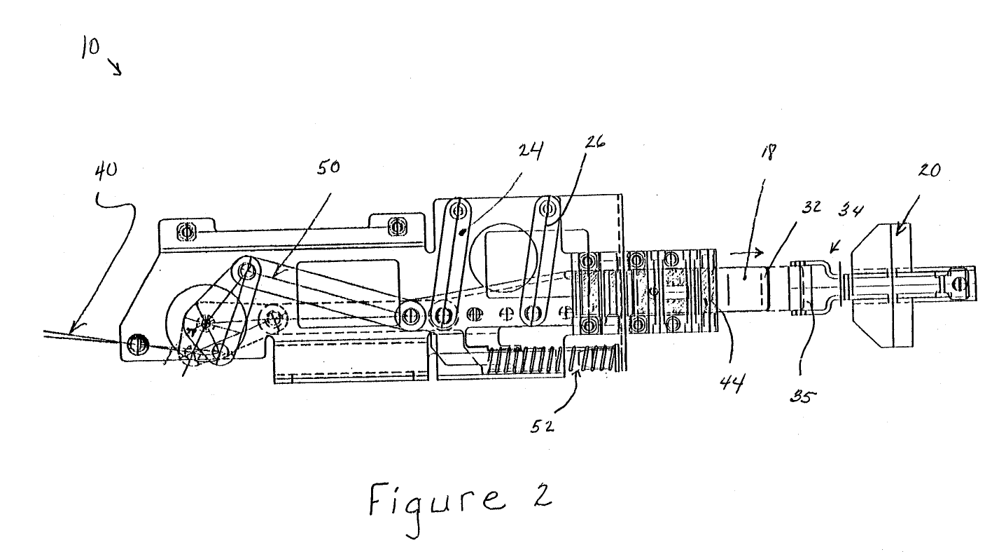

Reference is made to FIGS. 1-2 which illustrate the latch door operator of the invention, generally indicated as 10, which may be used in conjunction with an electric door operator for a multi-passenger vehicle, such as a bus. The latch door operator 10 supports the door panel 12, when in a closed position, against vacuum or sucking forces, caused by side air flow.

A sealing means 14 is provided on one of or both of the edge of the door panel 12 and/or on or within the door frame/wall portion 16 of the vehicle. The sealing means typically comprises a rubber sealing material, however any well known material may be used for sealing the vehicle door.

The essential components of the latch door operator comprises a striker member, generally indicated as 18, suspended within the door frame 16 which cooperates with a catcher member, generally indicated as 20. The catcher member 20 is pivotally mounted to the door by means of a pivot 22.

The striker member 18 is suspended on two swingers 24, 26 and supported by means for minimizing frictional drag such as rollers 28, sliders 30 and/or a combination of rollers 28 and sliders 30. A nose portion 32 is located at a first end of the striker member. This nose portion 32 is inclined at a predetermined angle with respect to the plane of the striker member 18 to enhance the sealing capability of such door. The nose portion 32 is also formed from any well known friction reducing material.

The catcher member 20 comprises a lever arm which has a first end portion 34 which is capable of cooperating with the nose portion 32 of the striker member 18 upon the application of an actuating force to the striker member 18. This actuating force causes the striker member 18 to move in a first direction to compress the sealing means 14 associated with the door 12 against one of a wall portion or the frame 16 of the transport vehicle and to latch the door 12 in a closed position.

The striker member 18 has an “S” shape including a central portion 36 and an end portion 38. The end portion of the striker member is engageable with an actuating means 40. The actuating means may be any well known actuating means such as a pull cable, a pneumatic cylinder or and electric solenoid. The “S” shape of the striker member 18 allows at least an end portion thereof to be contained within a wall 42 of the transit vehicle. This characteristic “S” shape also allows the striker to provide its action without interrupting the seals 14.

A slider box 44 may be positioned over at least a portion of the central portion 36 of the striker member 18. The slider box 44 may be formed from any well known material such as plastic, metal or a composite material.

The first end 34 of the catcher member 20 includes a friction reducing means. This friction 35 reducing means can be either a roller suspended from the end of the lever arm, a 90° slide formed of friction reducing material, and the like.

The second end 46 of the catcher member 20 is secured to the door panel 12 of the vehicle. The second end 46 of the catcher member 20 includes a biasing means such as a spring 48 for biasing the catcher member 20 against the nose portion 32 of the striker upon latching of the door in the closed position. This spring 48 has a predetermined tension which is capable of maintaining pressure on the door 12 in the closed position to compensate for wear of the sealing means 14 and to compensate for operational tolerances of the closing system such as the elasticity of the seals and the particular vehicle structure.

The latch door operator also includes a return spring 52 for returning the striker member 18 to its original or “open” position upon the release of the actuating means 40 and allows for opening of the door 12.

A toggle mechanism, generally indicated as 50, is associated with the striker member. This toggle mechanism allows for a high striking motion of the striker member 18 immediately prior to engagement of the striker member 18 with the catcher member. The movement of the toggle mechanism is limited to a predetermined distance so as to prevent the toggle from jumping through the dead point to assure emergency opening possibilities. Thus, the door may be opened even if the return spring 52 for the striker member 18 should become damaged.

The invention has been described in such full, clear, concise and exact terms so as to enable any person skilled in the art to which it pertains to make and use the same. It should be understood that variations, modifications, equivalents and substitutions for components of the specifically described embodiments of the invention may be made by those skilled in the art without departing from the spirit and scope of the invention as set forth in the appended claims. Persons who possess such skill will also recognize that the foregoing description is merely illustrative and not intended to limit any of the ensuing claims to any particular narrow interpretation.

We claim:

1. A latch door operator for improving the sealing capability of a door swingably mounted on a door frame of a multi-passenger mass transit vehicle, said door having sealing means associated therewith, said latch door operator comprising:
(a) a striker member suspended within such door frame, said striker member capable of moving in one of a first and second direction upon the application of a force thereto;
(b) an actuating means for applying one of an actuating and retracting force to said striker member;
(c) a nose portion located at a first end of said striker member; and
(d) a catcher member pivotally mounted to such door, said catcher member having a first end portion which is capable of cooperating with said nose portion of said striker member upon the application of an actuating force to said striker member causing said striker member to move in a first direction to compress such sealing means associated with such door against one of a wall portion or such frame of such transport vehicle and to latch such door in a closed position.

2. A latch door operator as recited in claim 1 wherein said nose portion of said striker member is inclined at a predetermined angle with respect to the plane of the striker member to enhance the sealing capability of such door.

3. A latch door operator as recited in claim 2 wherein said nose portion of said striker member is formed from a friction reducing material.

4. A latch door operator as recited in claim 1 wherein said striker member is supported by one of rollers, sliders, and a combination of rollers and sliders for minimizing frictional drag.

5. A latch door operator as recited in claim 1 wherein said striker member has an “S” shape including a central portion and an end portion, said end portion of said striker member being engageable with said actuating means.

6. A latch door operator as recited in claim 5 wherein said “S” shape of said striker member allows at least an end portion thereof to be contained within a wall of the transit vehicle.

7. A latch door operator as recited in claim 5 further including a slider box positioned over at least a portion of said central portion of said striker member.

8. A latch door operator as recited in claim 1 wherein said first end of said catcher member includes a friction reducing means.

9. A latch door operator as recited in claim 8 wherein said friction reducing means includes one of a roller and a 90° slide.

10. A latch door operator as recited in claim 1 wherein said catcher member includes a second end secured to such door.

11. A latch door operator as recited in claim 10 wherein said second end of said catcher member includes a biasing means for biasing said catcher member against said nose portion of said striker upon latching of such door in such closed position.

12. A latch door operator as recited in claim 11 wherein said biasing means comprises a spring having a predetermined tension which is capable of maintaining pressure on such door in such closed position to compensate for wear of such sealing means and operational tolerances.

13. A latch door operator as recited in claim 1 further including a toggle mechanism associated with said striker member allowing for a high striking motion of said striker member prior to engagement of said striker member with said catcher member.

14. A latch door operator as recited in claim 13 wherein said toggle movement is limited to a predetermined distance to assure an emergency opening.

15. A latch door operator as recited in claim 1 further including a return spring for said striker member for retracting said striker member and opening such door.
